(19) United States
(12) Patent Application Publication
(10) Pub. No.: US 2026/0364782 A1
(43) Pub. Date: Nov. 19, 2026

(54) SIX-AXIS PARALLEL ROBOT CAPABLE OF MEASURING AND MEASURING METHOD FOR USING THE SAME

(71) Applicant: DELTA ELECTRONICS, INC., Taoyuan City (TW)

(72) Inventors: Chun-Tse LEE, Taoyuan City (TW); Shi-Yu WANG, Taoyuan City (TW)

(21) Appl. No.: 19/371,603

(22) Filed: Oct. 28, 2025

(30) Foreign Application Priority Data
May 16, 2025 (CN) 202510632900.6

(51) Int. Cl. B25J 9/02; B25J 9/00; B25J 9/16

(52) U.S. Cl. CPC B25J 9/023; B25J 9/003; B25J 9/1607; B25J 9/1633

(57) ABSTRACT

A six-axis parallel robot including a moving platform, a base, and six actuators connected between the moving platform and the base through joints is disclosed. The moving platform has a target posture and multiple resisting forces. Each actuator includes a linear motor and a driver, where each driver executes: reading a current value of each linear motor when the moving platform is subjected to an external force smaller than a threshold; performing a compliant motion and reading a displacement of each linear motor when the external force exceeds the threshold; obtaining a current posture of the moving platform through a forward kinematics calculation based on the displacements; calculating equivalent force/torque of the moving platform relative to the external force based on the current values and the current posture; and, comparing the current posture with the target posture to calculate displacement/angle variation of the moving platform.

### BACKGROUND OF THE DISCLOSURE

### Technical Field

The present disclosure relates to a six-axis parallel robot, and in particularly to a six-axis parallel robot and its measuring method that can measure an equivalent force/equivalent torque of a moving platform while being subjected to an external force.

### Related Art

In automated production lines assembly process, six-axis (also called as six-degree-of-freedom) parallel robots are often used to assist in assembly. Such robots generally include two types which are active robots and passive devices.

Active robots are equipped with active motors and can provide active compensations; however, active robots, due to their high rigidity, cannot perform compliant motion when subjected to external forces.

General speaking, the moving platform and the actuators of the active robots would not operate correspondingly relative to the subjected external force, therefore, the active robots do not have the ability of measuring the external force. Besides, a part of the active robots can implement the compliant motion through modifying internal structure or arranging additional sensors (such as force/torque sensors or cameras). However, although the moving platform and/or actuators of this type of active robots can retract with respect to the external force being subjected, it still cannot measure the external force. In sum, the skilled person in the art need to improve the six-axis parallel robots.

### SUMMARY OF THE INVENTION

The object of the present disclosure is to provide a six-axis parallel robot capable of measuring and its measuring method, which can measure, while being subjected to an external force, the equivalent force/equivalent torque relative to the external force and the displacement of the moving platform caused by the external force.

In one of the exemplary embodiments, the six-axis parallel robot of the present disclosure includes a moving platform having a first surface, a base platform having a second surface, multiple first joint components respectively arranged on the first surface, multiple second joint components respectively arranged on the second surface, and six linear actuators respectively arranged between the moving platform and the base platform through the multiple first and second joint components. Each of the linear actuators respectively has a linear motor and a motor driver. The moving platform has a target posture and multiple resisting forces relative to multiple directions. In the present disclosure, each of the motor drivers is respectively configured to execute following actions:
controlling each corresponding linear motor to rotate based on a moving command to provide a thrust to maintain the moving platform at the target posture;
reading a current value of each corresponding linear motor and calculating a current variation in response to the moving platform subjected to an external force being smaller than or equal to a thrust threshold;
controlling each corresponding linear actuator to perform a compliant motion and reading a linear displacement variation of each corresponding linear motor in response to the moving platform subjected to the external force being greater than the thrust threshold;
calculating a Forward Kinematics calculation based on the linear displacement variation of each corresponding linear motor to obtain a current posture of the moving platform;
calculating an equivalent force and an equivalent torque of the moving platform relative to the external force based on the current variation of each corresponding linear motor and the current posture; and
comparing the current posture and the target posture to calculate a displacement and an angle variation of the moving platform.

In one of the exemplary embodiments, the measuring method of the present disclose is applied to the above six-axis parallel robot, and includes following steps:
step a) controlling, by each of the motor drivers, each corresponding linear motor to rotate based on a moving command to provide a thrust to maintain the moving platform at the target posture;
step b) reading, by each of the motor drivers, a current value of each corresponding linear motor and calculating a current variation in response to the moving platform subjected to an external force being smaller than or equal to a thrust threshold;
step c) controlling, by each of the motor drivers, each corresponding linear actuator to perform a compliant motion and reading a linear displacement variation of each corresponding linear motor in response to the moving platform subjected to the external force being greater than the thrust threshold;
step d) calculating, by each of the motor drivers, a Forward Kinematics calculation based on the linear displacement variation of each corresponding linear motor to obtain a current posture of the moving platform;
step e) calculating, by each of the motor drivers, an equivalent force and an equivalent torque of the moving platform relative to the external force based on the current variation of each corresponding linear motor and the current posture; and
step f) comparing, by each of the motor drivers, the current posture and the target posture to calculate a displacement and an angle variation of the moving platform.

Compared with related arts, the six-axis parallel robot of the present disclosure can be served as a six-axis force gauge, a displacement meter, and an attitude indicator, which can measure the equivalent force/equivalent torque relative to an external force as well as the displacement of the moving platform caused by the external force while being subjected to the external force.

### BRIEF DESCRIPTION OF THE DRAWINGS

FIG. 1 is a schematic diagram of the six-axis parallel robot of an embodiment according to the present disclosure.

FIG. 2 is a block diagram of the linear actuator of an embodiment according to the present disclosure.

FIG. 3 is a measuring flowchart of an embodiment according to the present disclosure.

FIG. 4A is a schematic diagram showing displacement measurement of an embodiment according to the present disclosure.

FIG. 4B is a schematic diagram showing angle measurement of an embodiment according to the present disclosure.

FIG. 4C is a schematic diagram showing force and torque measurement of an embodiment according to the present disclosure.

FIG. 5 is a schematic diagram showing the Forward Kinematics calculation of an embodiment according to the present disclosure.

FIG. 6 is a schematic diagram showing an external force calculation of an embodiment according to the present disclosure.

FIG. 7 is a schematic diagram showing a measurement result of an embodiment according to the present disclosure.

### DETAILED DESCRIPTION OF THE INVENTION

The present disclosure discloses a six-axis parallel robot capable of measuring (referred to as the six-axis parallel robot hereinafter). The six-axis parallel robot in the present disclosure is an active robot. Through modifying the actuators in the six-axis parallel robot to linear actuators that use linear motors, the rigidity of the actuators is reduced. Also, based on the inherent reverse-drivable characteristic of the linear motors, when being subjected to an external force, the linear actuators can provide a translational and/or rotational compensation to perform compliant motion. When performing the compliant motion, the variations of the linear displacement and the current value of the linear actuators can be used to calculate the equivalent force/equivalent torque relative to an external force encountered by the moving platform and the displacement of the moving platform, so as to use the six-axis parallel robot to directly serve as a six-axis force gauge, a displacement meter, and an attitude indicator.

Six-axis generally refers to a robot achieving operation in six degrees of freedom (DoF) through the coordinated motion of six driving elements (i.e., six linear actuators in the present disclosure). Therefore, the six-axis parallel robot in the present disclosure can also be called as a six-degree-of-freedom parallel robot. For the ease of understanding, the descriptions below will uniformly use the term “six-axis parallel robot” but not for limitation.

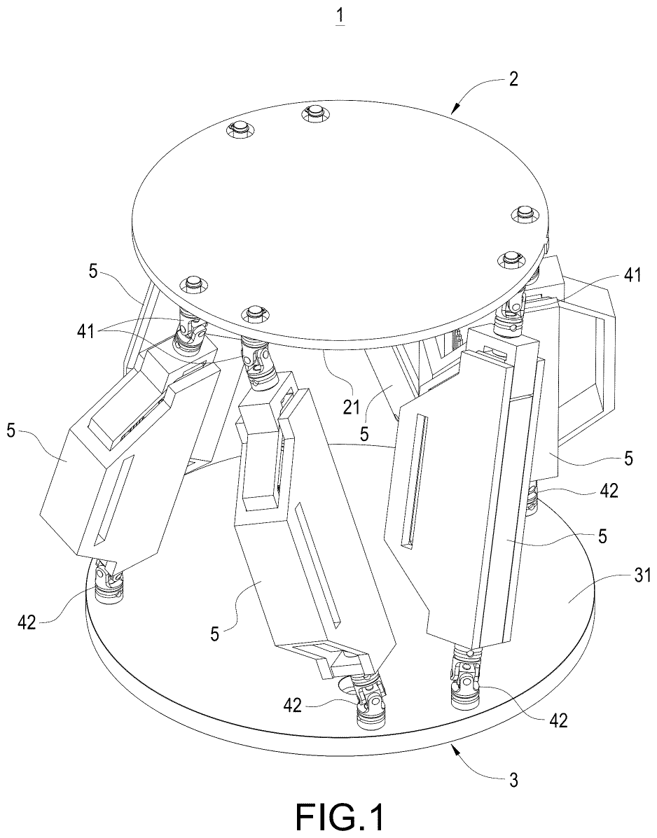

Please refer to FIG. 1, which is a schematic diagram of the six-axis parallel robot of an embodiment according to the present disclosure. FIG. 1 shows the structure of the six-axis parallel robot 1 of the present disclosure. As shown in FIG. 1, the six-axis parallel robot 1 of the present disclosure includes a moving platform 2, a base platform 3, multiple first joint components 41, multiple second joint components 42, and six linear actuators 5. The moving platform 2 is arranged with respect to the base platform 3, wherein the moving platform 2 has a first surface 21 in the direction toward the base platform 3 and the base platform 3 has a second surface 31 in the direction toward the moving platform 2. The amount of the multiple first joint components 41 is six, where the six first joint components 41 are respectively arranged on the first surface 21 of the moving platform 2. The amount of the multiple second joint components 42 is six, where the six second joint components 42 are respectively arranged on the second surface 31 of the base platform 3. In one of the exemplary embodiments, the multiple first join components 41 and the multiple second joint components 42 are universal joints or spherical joints.

The linear actuator 5 is elongated. One end of each of the six linear actuators 5 respectively connects with one of the first joint components 41 and another end of each of the six linear actuators 5 respectively connects with one of the second joint components 42. Therefore, the six linear actuators 5 are respectively arranged between the moving platform 2 and the base platform 3 through the six first joint components 41 and the six second joint components 42.

In one of the exemplary embodiments, the base platform 3 is set on a relatively stable position (for example, fixed on the ground or other supporting structure), while the moving platform 2 is a movable component of the six-axis parallel robot 1 which can be installed with an end effector. When using the six-axis parallel robot 1 to perform contact-base assembly processes, the moving platform 2 may be subjected to an external force. As discussed above, the six-axis parallel robot of the present disclosure uses the linear actuators 5 which are reverse-drivable. When the moving platform 2 is subjected to the external force and the external force exceeds a preset thrust threshold, the linear actuators 5 can retract within their mechanical limits to implement the compliant motion for the six-axis parallel robot. Besides, the linear actuators can calculate the equivalent force/equivalent torque of the moving platform 2 relative to the external force as well as the displacement and the angle variation of the moving platform 2 caused by the external force through algorithms while retracting, therefore, the six-axis parallel robot 1 can directly serve as the six-axis force gauge, the displacement meter, and the attitude indicator.

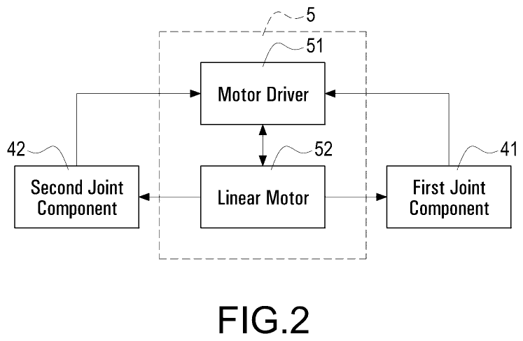

Please refer to FIG. 2 at the same time, wherein FIG. 2 is a block diagram of the linear actuator of an embodiment according to the present disclosure. As shown in FIG. 2, every linear actuator 5 in the present disclosure includes a motor driver 51 and a linear motor 52. The motor driver 51 connects to the linear motor 52 and controls the linear motor 52 to rotate through control commands. The linear motor 52 connects to a corresponding one of the first joint components 41 and a corresponding one of the second joint components 42 respectively at two ends of the linear actuator 5. When the linear motor 52 rotates, the first joint component 41 and/or the second joint component 42 can be brought by the linear motor 52 to rotate, thereby maintaining the moving platform 2 to be at a required target posture. The motor driver 51 can be connected to the first joint component 41 and the second joint component 42 as well. When the moving platform 2 is subjected to an external force, the motor driver 51 obtains the coordinates of the corresponding first joint component 41 and the corresponding second joint component 42 as well as the linear displacement of the linear motor 52, thereby measuring the external force.

It should be mentioned that the motor driver 51 may monitor the current value of the corresponding linear motor 52. In particularly, when the moving platform 2 is subjected to the external force, each linear motor 52 of each linear actuator 5 needs to increase its current value (i.e., increase the thrust toward the moving platform 2) to resist the external force. By continuously monitoring the current value of each linear motor 52 and calculate the variation of the current value, the motor drivers 51 may calculate the equivalent force and the equivalent torque relative to the external force (detailed described in the following).

After the six-axis parallel robot 1 is turned on, each motor driver 51 controls each corresponding linear motor 52 to rotate based on the moving command, thereby maintaining the moving platform 2 to be at a present target posture. When the moving platform 2 is maintained at the target posture, the six linear actuators 5 have a preset linear displacement (i.e., have a preset leg length). In one of the exemplary embodiments, each of the linear displacements is previously calculated based on the preset target posture. On the other hand, the six-axis parallel robot 1 can, based on user's operation, set multiple resisting forces for the moving platform 2 relative to multiple directions (such as moving directions along an X-axis, a Y-axis, or a Z-axis or rotating directions along the X-axis, the Y-axis, or the Z-axis) and set one or more thrust thresholds based on these resisting forces. When the moving platform 2 is subjected to the external force and the external force does not exceed any of these thrust thresholds, the moving platform 2 will not be pushed, and each of the motor drivers 51 will continuously controls each corresponding linear motor 52 to be at the linear displacement (however, the thrust being provided should be increase, thus the current value of each linear motor 52 will increase), so as to maintain the moving platform 2 to be at the target posture. When the moving platform 2 is subjected to the external force and the external force exceeds one or more of the thrust thresholds (i.e., exceeds one of the multiple resisting forces), each of the motor drivers 51 controls each corresponding linear motor 52 to retract to implement the compliant motion.

In one of the exemplary embodiments, when the moving platform 2 is subjected to the external force, the six-axis parallel robot performs an analysis calculation as described below on the external force through each motor driver 51 of each linear actuator 5. In another embodiment, the six-axis parallel robot 1 performs the analysis calculation as described below on the external force through one or more controllers (not shown in the FIGs). For the ease of understanding, the description below takes each motor driver 51 to execute algorithms to analyze the external force as an example for interpretation, but not limited thereto.

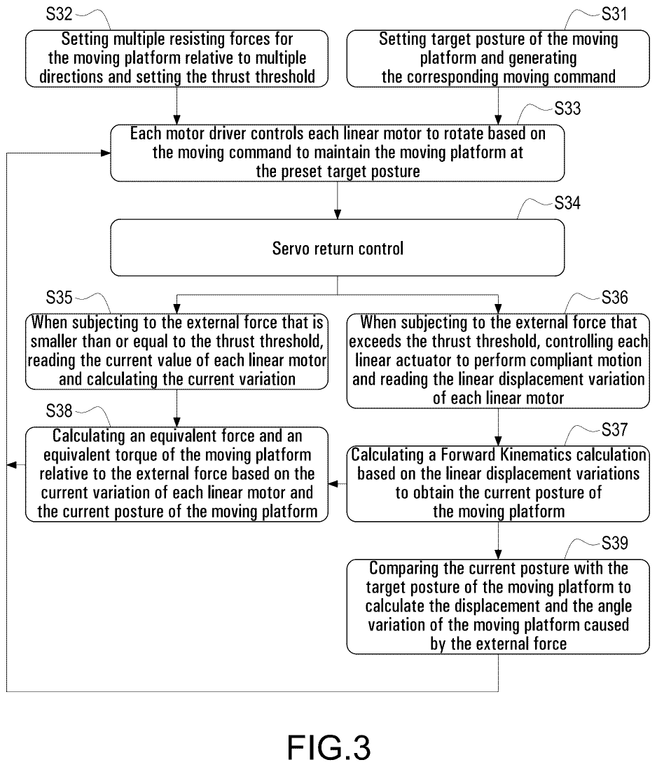

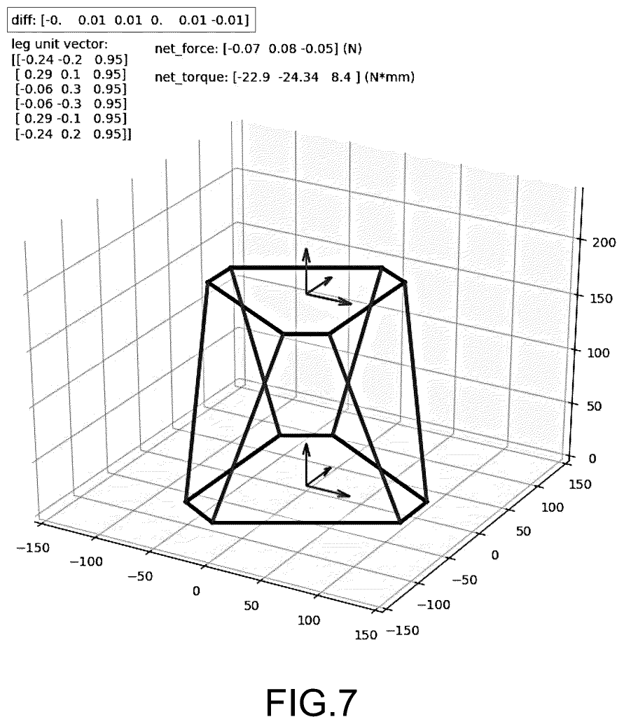

Please refer to FIG. 3 at the same time, which is a measuring flowchart of an embodiment according to the present disclosure. First, the six-axis parallel robot 1 receives an external operation through a human-machine interface (such as the human-machine interface as shown in FIG. 7) to set the target posture of the moving platform 2. Also, each motor driver 51 may generate the moving command of controlling each corresponding linear motor 52 based on the target posture (step S31). Besides, the six-axis parallel robot 1 may simultaneously set the multiple resisting forces for the moving platform 2 relative to multiple directions through the external operation and set a thrust threshold based on the multiple resisting forces (step S32). In one of the exemplary embodiments, the resisting forces include three-axis force and three-axis torque in the Cartesian coordinate system. The three axes include the X-axis, the Y-axis, and the Z-axis. When the moving platform 2 is subjected to an external force exceeding the thrust threshold, each motor driver 51 controls each corresponding linear actuator 5 to retract to implement the compliant motion. Also, each motor driver 51 detects the linear displacement and the current variation of each linear motor 52 to measure the external force.

It should be mentioned that the target posture set by the user is a posture in the Cartesian coordinate system, so the target posture should be transformed to the moving commands that can be used to directly control each of the linear motors 52. To do this, the present disclosure applies an Inverse Kinematics calculation to perform the transformation. In one of the exemplary embodiments, after the user sets the target posture of the moving platform 2, each motor driver 51 performs the Inverse Kinematics calculation based on the target posture to obtain the linear displacement that each corresponding linear actuator 5 needs to follow to maintain the moving platform 2 at the target posture, and then generates a corresponding moving command based on the corresponding linear displacement. Therefore, when each motor driver 51 respectively controls each corresponding linear motor 52 to rotate based on each corresponding moving command, the thrust generated by each linear motor 52 can maintain the moving platform 2 at the target posture.

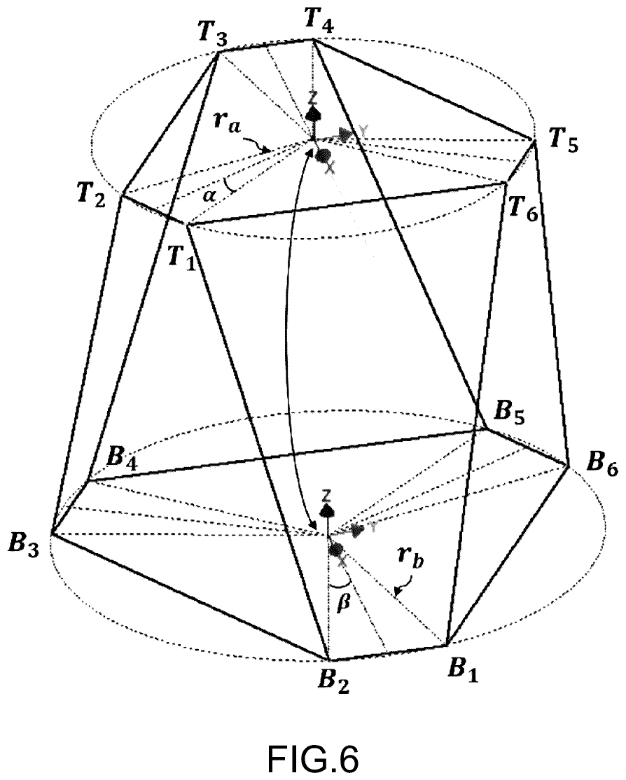

In one of the exemplary embodiments, each motor driver 51 executes the following steps to perform the Inverse Kinematics calculation. To perform the Inverse Kinematics calculation, the structure of the six-axis parallel robot 1 should be first defined (such as the structure definition shown in FIG. 6), the definition includes the target posture (i.e., the target posture inputted in previous step S31) of the moving platform 2 relative to a base platform coordinate system used by the base platform 3, a first distance rₐ between a central point of the moving platform 2 and each of the first joint components 41, a second distance r_{b} between a central point of the base platform 3 and each of the second joint components 42, a first angle α representing half the value of the angle between two closest first joint components 41 on the moving platform 2, and a second angle β representing half the value of the angle between two closest second joint components 42 on the base platform 3. In the present disclosure, a controller or each motor driver 51 is used to input the above information into an Inverse Kinematics formula to perform calculation.

Next, based on the Inverse Kinematics calculation, the controller or each motor driver 51 calculates second coordinate positions B₁~B₆ of the second joint components 42 on the base platform coordinate system based on the second distance r_{b} and the second angle β. The calculation formula is exampled as following:

$$B 1 = [ {r}_{b} cos ( β ) , {r}_{b} sin ( β ) , 0 ] ;$$

$$B 2 = [ {r}_{b} cos ( - β ) , {r}_{b} sin ( - β ) , 0 ] ;$$

$$B 3 = [ {r}_{b} cos ( \frac{- 2 π}{3} + β ) , {r}_{b} sin ( \frac{- 2 π}{3} + β ) , 0 ] ;$$

$$B 4 = [ {r}_{b} cos ( \frac{- 2 π}{3} - β ) , {r}_{b} sin ( \frac{- 2 π}{3} - β ) , 0 ] ;$$

$$B 5 = [ {r}_{b} cos ( \frac{- 4 π}{3} + β ) , {r}_{b} sin ( \frac{- 4 π}{3} + β ) , 0 ] ;$$

$$B 6 = [ {r}_{b} cos ( \frac{- 4 π}{3} - β ) , {r}_{b} sin ( \frac{- 4 π}{3} - β ) , 0 ] .$$

Next, the controller or each motor driver 51 further calculates first coordinate positions T₁~T₆ of the first joint components 41 on the base platform coordinate system based on the first distance rₐ and the first angle α. It should be mentioned that the first coordinate positions T₁~T₆ being calculated have not passed the coordinate transformation procedure, so these positions are not actual positions of the multiple first joint components 41. The calculation formula for the first coordinate positions T₁~T₆ is exampled as following:

$$T 1 = [ {r}_{a} cos ( \frac{- π}{3} + α ) , {r}_{a} sin ( \frac{- π}{3} + α ) , 0 ] ;$$

$$T 2 = [ {r}_{a} cos ( \frac{- π}{3} - α ) , {r}_{a} sin ( \frac{- π}{3} - α ) , 0 ]$$

$$T 3 = [ {r}_{a} cos ( - π + α ) , {r}_{a} sin ( - π + α ) , 0 ] ;$$

$$T 4 = [ {r}_{a} cos ( - π - α ) , {r}_{a} sin ( - π - α ) , 0 ] ;$$

$$T 5 = [ {r}_{a} cos ( \frac{- 5 π}{3} + α ) , {r}_{a} sin ( \frac{- 5 π}{3} + α ) , 0 ] ;$$

$$T 6 = [ {r}_{a} cos ( \frac{- 5 π}{3} - α ) , {r}_{a} sin ( \frac{- 5 π}{3} - α ) , 0 ] .$$

Next, the controller or each motor driver 51 performs coordinate transformation matrix multiplication on the first coordinate positions T₁~T₆ of each of the first joint components 41 in sequence, based on the target posture of the moving platform 2 relative to the base platform coordinate system, and then calculates a Euclidean Distance between the transformed coordinate position of each first joint component 41 and its corresponding second joint component 42, to obtain the corresponding linear displacement of each linear actuator 5. The detailed formula is:

for i=0 to 5 do:

\vec{T}_{i,temp}=H_{4×4}·T[i];

l_{leg}=∥B[i+1]−\vec{T}_{i,temp}∥;

\vec{l}[i]=l_{leg};

Wherein, H_{4×4} represents the Homogeneous transformation matrix of transforming the target posture [X Y Z A B C]^{T}, T[i] represents the first coordinate position of each first joint component 41 relative to the base platform coordinate system, l_{leg} represents the linear displacement of each linear actuator 5, 7 [i] represents the aggregation of the linear displacements of the six linear actuators 5.

Through using the Inverse Kinematics calculation, the controller or each motor driver 51 can transform the target posture of the moving platform 2 set by the user to the linear displacements that each linear actuator 5 needs to follow. Therefore, the controller or each motor driver 51 can generate the moving command of controlling each corresponding linear motor 52 based on each corresponding linear displacement.

After the step S31 and the step S32, each motor driver 51 respectively controls, based on each corresponding moving command, each corresponding linear motor 52 to rotate to provide a thrust toward the moving platform 2, thereby maintaining the moving platform 2 to be at the preset target posture (step S33). Meanwhile, each motor driver 51 continuously monitors the position (i.e., the linear displacement) and the current value of each linear motor 52. Also, each motor driver 51 continuously performs servo return control while the six-axis parallel robot 1 is operating (step S34), thus performing the compliant motion when being subjected to the external force and the external force exceeds the thrust threshold, and restoring the moving platform 2 back to the target posture when the external force reduces to be smaller than the thrust threshold or the external force disappears.

In particularly, when the moving platform is subjected to the external force and the external force is smaller than or equal to the thrust threshold, each motor driver 51 reads the current value of each linear motor 52 and calculate the current variation of each linear motor 52 (step S35). Based on the current variation of each linear motor 52, each motor driver 51 can calculate the equivalent force and the equivalent torque relative to the external force.

On the other hand, when the moving platform 2 is subjected to the external force and the external force exceeds the thrust threshold, each motor driver 51 reverse-drives each corresponding linear motor 52 for each linear actuator 5 to perform the compliant motion, and each motor driver 51 reads the linear displacement variation of each linear motor 52 (step S36). In other words, each motor driver 51 calculates a difference between a first linear displacement of the corresponding linear motor 52 when the moving platform 2 is at the target posture and a second linear displacement of the corresponding linear motor 52 after the moving platform 2 moves due to the external force. It should be mentioned that when being subjected to the external force, each motor driver 51 simultaneously and continuously executes the step S35 through the step S36, thus the step S35 and the step S36 do not have an execution order.

Next, each motor driver 51 calculates a Forward Kinematics calculation based on the linear displacement variation of each linear motor 52 to obtain a current posture of the moving platform 2 (step S37). Because the external force encountered by the moving platform 2 exceeds the thrust threshold, each linear actuator 5 starts to retract, and the current posture of the moving platform 2 will be different from the target posture. In the present disclosure, the current posture includes the displacement and the angle caused by the movement of the moving platform 2 after being subjected to the external force, i.e., the difference between the current posture and the target posture includes a displacement variation and an angle variation.

After obtaining the current variation of each linear motor 52 in the step S35 and obtaining the current posture of the moving platform in the step S37, each motor driver 51 further calculates an equivalent force and an equivalent torque of the moving platform 2 relative to the external force based on the current variation of each linear motor 52 and the current posture of the moving platform 2 (step S38). In addition, each motor driver 51 compares the current posture with the target posture of the moving platform 2 to calculate the displacement and the angle variation of the moving platform 2 caused by the external force (step S39).

As disclosed in above steps, while the moving platform 2 is subjected to the external force, each motor driver 51 continuously monitors the linear displacement variation and the current variation of each linear motor 52 and calculates the equivalent force and the equivalent torque relative to the external force based on these variations, and then calculates the displacement and the angle variation of the current posture of the moving platform 2 with respect to the target posture of the moving platform 2. When the external force disappears or becomes smaller than the thrust threshold, each motor driver 51 controls each corresponding linear motor 52 to rotate based on the moving command, thus providing the thrust to restore the moving platform 2 back to the target posture. Therefore, the servo return control can be implemented.

Through using the above steps, the six-axis parallel robot 1 of the present disclosure can measure the equivalent force and the equivalent torque relative to the external force when the moving platform 2 is subjected to the external force and determine the displacement and the angle variation of the moving platform 2 caused by the external force, therefore using the six-axis parallel robot to serve as a six-axis force gauge, a displacement meter, or an attitude indicator.

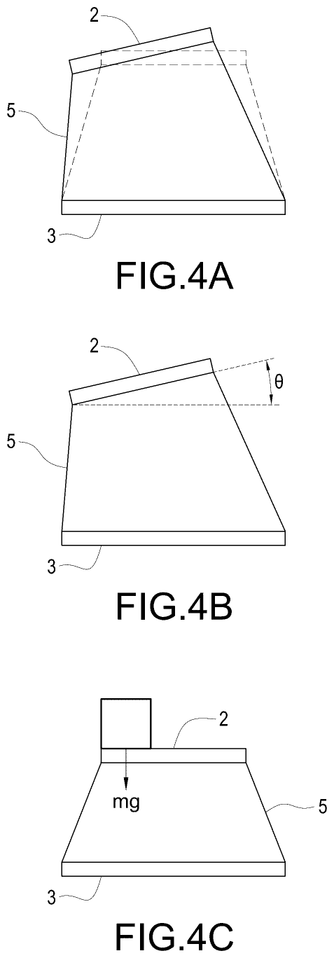

Please refer to FIG. 4A through FIG. 4C, wherein FIG. 4A is a schematic diagram showing displacement measurement of an embodiment according to the present disclosure, FIG. 4B is a schematic diagram showing angle measurement of an embodiment according to the present disclosure, and FIG. 4C is a schematic diagram showing force and torque measurement of an embodiment according to the present disclosure.

As shown in FIG. 4A, when the moving platform is subjected to the external force and the external force exceeds the preset thrust threshold, each linear actuator 5 may be pushed away by the external force, causing the moving platform 2 to leave the target posture. At the meantime, the linear displacement of each linear actuator 5 (i.e., the leg length) will be different from the linear displacement indicated by each moving command. Based on this difference, each motor driver 51 of each linear actuator 5 can perform the Forward Kinematics calculation to obtain the displacement of the moving platform 2, thus using the six-axis parallel robot 1 to serve as the displacement meter.

As shown in FIG. 4B, when the moving platform 2 is subjected to the external force and the external force exceeds the preset thrust threshold, each linear actuator 5 will be pushed away by the external force, causing the moving platform 2 to leave the target posture. In the meantime, the moving platform 2 will generate an angle variation θ for each axis relative to the horizontal plane parallel to the base platform 3. Based on these angle variations, each motor driver 51 of each linear actuator 5 can perform the Forward Kinematics calculation to obtain the current posture of the moving platform 2, thus using the six-axis parallel robot 1 to serve as the attitude indicator.

As shown in FIG. 4C, when the moving platform 2 is subjected to the external force, each linear motor 52 of each linear actuator 5 increases its thrust to resist the external force, causing the current value of each linear motor 52 to vary. Similarly, if each linear actuator 5 is pushed away by the external force, each linear motor 52 will generate a linear displacement variation as well. Based on these variations, each motor driver 51 of each linear actuator 5 can perform the Forward Kinematics combining with the current information to calculate the equivalent force/equivalent torque relative to the external force, thus using the six-axis parallel robot 1 to serve as the six-axis force gauge.

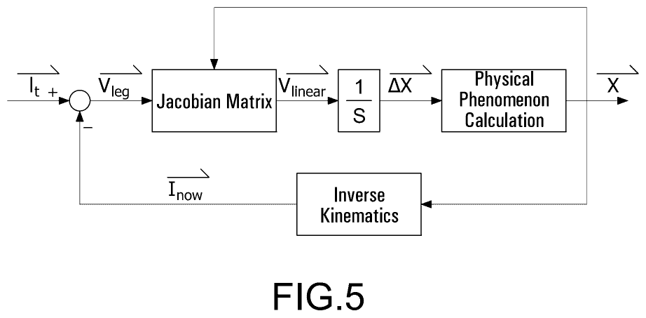

Please refer to FIG. 5 at the same time, which is a schematic diagram showing the Forward Kinematics calculation of an embodiment according to the present disclosure. As discussed above, the present disclosure detects the linear displacement variation of each linear actuator 5 when the moving platform 2 is subjected to the external force and performs the Forward Kinematics calculation to obtain the current posture of the moving platform 2 after being subjected to the external force. In particularly, the present disclosure uses the controller or each of the motor drivers 51 to perform the Forward Kinematics calculation through the following steps. For the ease of understanding, the description below takes each motor driver 51 to perform the Forward Kinematics calculation as an example for interpretation.

As shown in FIG. 5, when performing the Forward Kinematics calculation, each motor driver 51 performs calculation in an iterative manner until a target result converges to output a final pose. Among this, the input of the iterative calculation is the current linear displacements of the six linear actuators 5, while the output is the current posture of the moving platform 2. To be more specifically, the iterative calculation of the present disclosure is a virtual movement process that calculates the gradual movement of the six linear actuators 5 from their initial lengths (i.e., the linear displacements before being subjected to an external force) to their linear displacements after being subjected to the external force. During the virtual movement process, a Jacobian Matrix is calculated based on the velocity of movement (i.e., change in the linear displacements) to obtain a minute position change amount. After adjusting the estimated posture of the moving platform 2 based on this minute position change amount, feedback is performed. Finally, when the entire result converges, the iterative calculation ends and a final estimated posture of the moving platform 2 is outputted. During the feedback process, the linear displacements of the six linear actuators 5 will increasingly approach the target linear displacements after being subjected to the external force, so the final output estimated posture can approach or be equal to the true posture of the moving platform 2 after being subjected to the external force.

First, each motor driver 51 obtains the current posture \vec{X} of the moving platform 2 and performs the Inverse Kinematics calculation based on the current posture \vec{X} to obtain the current linear displacement \vec{l_{now}} of each linear motor 52. The Inverse Kinematics calculation is same as the descriptions mentioned above, detailed description is omitted here.

Next, each motor driver 51 calculates a displacement error \vec{error_{leg}} between the current linear displacement \vec{l_{now}} and the target linear displacement \vec{lₜ} caused by the external force of each linear motor 52 and then calculates a linear displacement velocity array \vec{v_{leg}} required by each linear actuator 5 based on the displacement error \vec{error_{leg}} and a time coefficient of an iteration algorithm. Next, each motor driver 51 calculates the Jacobian Matrix based on the current posture \vec{X} of the moving platform 2, and then uses the Jacobian Matrix to transform the linear displacement velocity array \vec{v_{leg}} into a second linear displacement velocity array \vec{vₗᵢₙₑₐᵣ} required by the central point of the moving platform 2.

Furthermore, each motor driver 51 adds the current posture \vec{X} of the central point of the moving platform 2 within the iteration process to the second linear displacement velocity array \vec{vₗᵢₙₑₐᵣ} required by the central point of the moving platform 2, so as to generate an updated current posture within the iteration process (i.e., \vec{X}=\vec{X}+\vec{vₗᵢₙₑₐᵣ} *Δt). Wherein, the “1/S” shown in FIG. 5 is to execute \vec{vₗᵢₙₑₐᵣ} *Δt, and \vec{vₗᵢₙₑₐᵣ} *Δt=Δ\vec{X}, so the equation will finally become \vec{X}=\vec{X}+Δ\vec{X}. The “physical phenomenon calculation” shown in FIG. 5 represents \vec{X}=\vec{X}+Δ\vec{X}. Therefore, the posture variation of the six-axis parallel robot 1 within the iteration process can be obtained.

During the iteration process, each motor driver 51 further performs the Inverse Kinematics calculation based on the updated current posture \vec{X} to update the current linear displacement \vec{l_{now}} of each linear motor 52 within the iteration process. Also, each motor driver 51 repeatedly executes the above actions to perform iterative updating calculation until all the displacement errors \vec{error_{leg}} of each linear motor 52 converge to a present accurate value criteria_{accuracy}, to terminate the iterative calculation. After the iterative calculation ends, each motor driver 51 outputs the last updated current posture \vec{X} to be the current posture (i.e., the estimated posture) of the moving platform 2.

In particularly, the calculation steps of the aforementioned Forward Kinematics calculation can be performed through following pseudo code:

```
  input: current posture \vec{X}, current leg length \vec{l_{now}}, target leg length l\vec{ₜ},
time_coefficient, criteria_{accuracy}
  output: estimated posture \vec{Xₑ}
  criteria_{accuracy} = 0.001
  While error_{leg} < criteria_{accuracy}:
      error_{leg} = \vec{lₜ} − \vec{l_{now}}
    v_{leg} = error_{leg} * time_coefficient
        J = Jacobian(\vec{X})
        vₗᵢₙₑₐᵣ = J · v_{leg}
        \vec{X} = \vec{X} + vₗᵢₙₑₐᵣ
      \vec{l_{now}} = Inverse Kinematics(\vec{X})
  end
  return \vec{Xₑ} = \vec{X}
```

As disclosed by the above pseudo code, the iterative calculation of the present disclosure calculates the current linear displacement \vec{l_{now}} of each linear actuator 5 until each displacement error error_{leg} between the current linear displacement \vec{l_{now}} and the corresponding target linear displacement \vec{lₜ} caused by the external force is smaller than the present accurate value criteria_{accuracy}, to determine convergence. Besides, each motor driver 51 regards the last updated current posture \vec{X} being calculated before the calculation result converges as the estimated posture Xₑ (i.e., the final output current posture) of the moving platform 2 after being subjected to the external force.

In one of the exemplary embodiments, the controller or each motor driver 51 applies following steps to generate the Jacobian Matrix based on the current posture \vec{X} of the moving platform 2. For the ease of understanding, the following description takes each motor driver 51 to generate the Jacobian Matrix as an example for interpretation.

In the present disclosure, the Jacobian matrix is a 6×6 matrix arranged with [X Y Z A B C]^{T} as the first-order partial derivatives. Assuming J is the Jacobian matrix, then it can be defined as [symbol] =J [symbol] , wherein [symbol] =[\dot{X} \dot{Y} Ż \dot{A} \dot{B} Ċ]^{T}, representing the Cartesian coordinate system of linear velocity of the moving platform 2 (end effector); [symbol] =[\dot{l}₁ \dot{l}₂ \dot{l}₃ \dot{l}₄ \dot{l}₅ \dot{l}₆]^{T}, representing the linear velocities of the linear actuators 5. X, Y, and Z in the Jacobian matrix represent the position of each end point of the moving platform 2 on the Cartesian coordinate system, including the X representing the position on the X-axis, Y representing the position on the Y-axis, and Z representing the position on the Z-axis; A, B, C represent the orientation of each end point of the moving platform 2, for example, A, B, and C respectively represent Roll, Pitch, and Yaw in Euler Angles. T represents transpose.

First, each motor driver 51 inputs the current posture \vec{X} of the moving platform 2 and inputs a preset minute gain change amount (Increment small), this minute gain change amount may be, for example but not limited to, 0.1 or 0.2, etc. Next, each motor driver 51 creates a posture array [X Y Z A B C]^{T} and designates any value in the posture array as the minute gain change amount. For example, each motor driver 51 creates a posture array such as [0 0 0 0 0 0]^{T} and designates the value of any matrix element (such as the first element) in this posture array as the preset minute gain change amount (such as 0.1), so a posture array [0.1 0 0 0 0 0]^{T} can be obtained. Wherein, 0.1 is the value of the ith matrix component \vec{X}_{inc} (wherein i=1~6).

Next, each motor driver 51 respectively calculates a linear displacement before changing of each linear actuator 5 under the current posture \vec{X} through the Inverse Kinematics calculation (i.e., \vec{l}_{before}=Inverse Kinematcis(Pos_{now})), adds the current posture \vec{X} with the minute gain change amount to generate a changed posture, and then calculates a linear displacement post changing of each linear actuator 5 under the changed posture (i.e., \vec{l}_{after}=Inverse Kinematcis(Pos_{now}+[Incrementₛₘₐₗₗ, 0,0,0,0,0]^{T})). Next, each motor driver 51 calculates a difference between the linear displacement before changing and the linear displacement post changing (i.e., \vec{ι}=\vec{ι}_{after}−\vec{ι}_{before}, wherein \vec{ι} is the difference), and finally, uses this difference and the value of the matrix element in the posture array after the minute gain change amount being added to calculate the final value of the corresponding matrix element in the Jacobian matrix.

Taking the above Jacobian matrix J as an example, [symbol] =J [symbol] is:

$$[ \begin{matrix}\dot{X} \\ \dot{Y} \\ \dot{Z} \\ \dot{A} \\ \dot{B} \\ \dot{C}\end{matrix} ] = [ \begin{matrix}{J}_{1 ( 1 \times 6 )} \\ 0 \\ 0 \\ 0 \\ 0 \\ 0\end{matrix} ] [ \begin{matrix}{i}_{1} \\ {i}_{2} \\ {i}_{3} \\ {i}_{4} \\ {i}_{5} \\ {i}_{6}\end{matrix} ] ,$$

wherein J_{1(1×6)} is the value of the matrix element of the posture matrix being added with the minute gain change amount.

Finally, each motor driver 51 repeatedly executes the aforementioned actions for six times, until the final values of all the six matrix elements in the Jacobian matrix are obtained. In particularly, the controller or each motor driver 51 can obtain a 1×6 matrix element (i.e., J_{1(1×6)}) by executing the aforementioned actions for one time. After the aforementioned actions are executed for six times, six 1×6 matrix elements are obtained. After stacking these six matrix elements, a complete 6×6 Jacobian matrix can be obtained. By using the Jacobian matrix, each motor driver can obtain a force distribution of each linear actuator 5, thereby in the next step, each motor driver 51 can obtain the second linear displacement velocity array \vec{vₗᵢₙₑₐᵣ} of the central point of the moving platform 2 through multiplies the Jacobian Matrix with the linear displacement velocity array \vec{v_{leg}} of each actuator 5.

Please refer to FIG. 6 at the same time, which is a schematic diagram showing an external force calculation of an embodiment according to the present disclosure. As discussed above, when the moving platform 2 is subjected to the external force, the controller or each motor driver 51 may calculate the equivalent force and the equivalent torque relative to the external force based on the current value of each linear motor 52 and the current posture of the moving platform 2. For the ease of understanding, the following description takes each motor driver 51 to execute the following steps to calculate the equivalent force and the equivalent torque as an example for interpretation.

First, each motor driver 51 obtains linear thrust vector fᵢ of each linear actuator 5, wherein the linear thrust vector is directly relevant to the current value of each linear motor 52. In particularly, for resisting the external force, the thrust provided by each linear motor 52 toward the moving platform 2 may increase, thus the current value of each linear motor 52 increases correspondingly. In other words, when the current values of the linear motors 52 change, the thrusts change correspondingly. Next, each motor driver 51 calculates a first coordinate position Tᵢ of each first joint component 41 represented by the base platform coordinate system used by the base platform 3 and a second coordinate position Bᵢ of each second joint component 42 represented by the base platform coordinate system through the Inverse Kinematics calculation. The base platform 3 is arranged on a relative stable position (such as on the ground), so the second coordinate position Bᵢ of each second joint component 42 can be regarded as fixed. On the other hand, the first coordinate position Tᵢ of each first joint component 41 changes along with the current posture of the moving platform 2 after the moving platform 2 is subjected to the external force.

In one of the exemplary embodiments, an initial coordinate position T_{i,init} of each of the first joint components 41 can be represented as:

$${T}_{1 , init} = [ {r}_{a} cos ( \frac{- π}{3} + α ) , {r}_{a} sin ( \frac{- π}{3} + α ) , 0 ] ;$$

$${T}_{2 , init} = [ {r}_{a} cos ( \frac{- π}{3} - α ) , {r}_{a} sin ( \frac{- π}{3} - α ) , 0 ] ;$$

$${T}_{3 , init} = [ {r}_{a} cos ( - π + α ) , {r}_{a} sin ( - π + α ) , 0 ] ;$$

$${T}_{4 , init} = [ {r}_{a} cos ( - π - α ) , {r}_{a} sin ( - π - α ) , 0 ] ;$$

$${T}_{5 , init} = [ {r}_{a} cos ( \frac{- 5 π}{3} + α ) , {r}_{a} sin ( \frac{- 5 π}{3} + α ) , 0 ] ;$$

$${T}_{6 , init} = [ {r}_{a} cos ( \frac{- 5 π}{3} - α ) , {r}_{a} sin ( \frac{- 5 π}{3} - α ) , 0 ] .$$

Each motor driver 51 multiplies the initial coordinate position T_{i,init} of each of the first joint components 41 with the homogeneous transformation matrix corresponding to the current posture of the moving platform 2, to obtain the first coordinate position Tᵢ of each of the first joint components 41, i.e., Tᵢ=H_{4×4}·T_{i,init}, wherein H_{4×4} represents the homogeneous transformation matrix corresponding to the current posture of the moving platform 2.

The Inverse Kinematics calculation in this embodiment is identical to that disclosed above, the detailed description is omitted here.

Next, each motor driver 51 calculates a Euclidean distance \vec{B_{ι}T_{ι}}, of a connection line between each second joint component 42 and its corresponding first joint component 41 based on these first coordinate positions Tᵢ and these second coordinate positions Bᵢ, and then, based on these Euclidean distances \vec{B_{ι}T_{ι}}, calculates a unit vector \vec{n}_{ι} of the connection line between each second joint component 42 and its corresponding first joint component 41. Next, each motor driver 51, based on the linear thrust vector fᵢ and the unit vector \vec{n_{ι}} of each liner actuator 5, calculates an equivalent force F of the moving platform 2 relative to the external force.

On the other hand, each motor driver 51 further calculates connection vectors between the central position of the base platform 3 and each of the second joint components 42 to serve as a force arm \vec{OB_{ι}} required for calculating the torque, and then calculates the equivalent torque T of the moving platform 2 relative to the external force based on the force arm \vec{OB_{ι}} and the equivalent force F.

In one of the exemplary embodiments, each motor driver 51 can calculate the unit vector, the equivalent force, and the equivalent torque based on the following first formula, second formula, and third formula:

$$\vec{{n}_{ι}} = \frac{\vec{{B}_{ι} {T}_{ι}}}{\vert \vec{{B}_{ι} {T}_{ι}} \vert} ; \qquad first formula$$

$$F = - {\sum }_{i = 1}^{6} {f}_{i} \vec{{n}_{ι}} ; \qquad second formula$$

$$T = - {\sum }_{i = 1}^{6} \vec{{OB}_{ι}} \times {f}_{i} \vec{{n}_{ι}} . \qquad third formula$$

As the formulas mentioned above, wherein \vec{n_{ι}} represents the unit vector of the connection line between each second joint component 42 and each corresponding first joint component 41, \vec{B_{ι}T_{ι}} represents the Euclidean distance of the connection line between each second joint component 42 and each corresponding first joint component 41, F represents the equivalent force, fᵢ represents the linear thrust vector array of each linear actuator 5, T represents the equivalent torque, \vec{OB_{ι}} represents the connection vector (i.e., the force arm) between the central position of the base platform 3 and each second joint component 42.

Please refer to FIG. 7, which is a schematic diagram showing a measurement result of an embodiment according to the present disclosure. FIG. 7 discloses a display screen of a human-machine interface corresponding to the six-axis parallel robot 1 of the present disclosure. As shown in FIG. 7, a control system (not shown) of the six-axis parallel robot 1 may include a simulation model of the six-axis parallel robot 1, wherein the simulation model reflects every change of the six-axis parallel robot 1 generated after being subjected to the external force. For example, the human-machine interface in FIG. 7 shows the simulation model corresponding to the six-axis parallel robot 1 and shows that the displacement and the angle variation of the moving platform 2 after being subjected to the external force are: diff: [−0 0.01 0.01 0 0.01 −0.01], shows the equivalent force relative to the external force is: net force: [−0.07 0.08 −0.05] (N) and the equivalent torque relative to the external force is: net_torque: [−22.9 −24.34 8.4] (N*mm). However, FIG. 7 only discloses one of the exemplary embodiments of the present disclosure, the control system can indicate and show the equivalent force, the equivalent torque, and the displacement and the angle variation of the moving platform through different manners, and it is not limited to the human-machine interface as shown in FIG. 7.

Through the aforementioned technical solutions, the user may use the six-axis parallel robot to directly serve as a six-axis force gauge, a displacement meter, and an attitude indicator, thus measuring the equivalent force/the equivalent torque relative to an external force as well as the displacement of the moving platform caused by the external force when being subjected to the external force.

What is claimed is:

1. A six-axis parallel robot capable of measuring, comprising:
a moving platform, having a first surface;
a base platform, having a second surface;
multiple first joint components, respectively arranged on the first surface;
multiple second joint components, respectively arranged on the second surface;
six linear actuators, respectively arranged between the moving platform and the base platform through the multiple first joint components and the multiple second joint components, and each of the linear actuators respectively having a linear motor and a motor driver, wherein the moving platform has a target posture and multiple resisting forces relative to multiple directions, and each of the motor drivers is configured to execute following actions:
action a) controlling each corresponding linear motor to rotate based on a moving command to provide a thrust to maintain the moving platform to be at the target posture;
action b) reading a current value of each linear motor and calculating a current variation in response to the moving platform being subjected to an external force that is smaller than or equal to a thrust threshold;
action c) controlling each corresponding linear actuator to perform a compliant motion and reading a linear displacement variation of each linear motor in response to the moving platform being subjected to the external force that exceeds the thrust threshold;
action d) calculating a Forward Kinematics calculation based on the linear displacement variation of each linear motor to obtain a current posture of the moving platform;
action e) calculating an equivalent force and an equivalent torque of the moving platform relative to the external force based on the current variation of each linear motor and the current posture; and
action f) comparing the current posture and the target posture to calculate a displacement and an angle variation of the moving platform.

2. The six-axis parallel robot of claim 1, wherein each of the motor drivers is further configured to respectively execute following actions:
action a01) receiving an external operation to set the target posture of the moving platform and generating the moving command of controlling each corresponding linear motor based on the target posture; and
action a02) receiving the external operation to set the multiple resisting forces of the moving platform relative to the multiple directions and set the thrust threshold based on the multiple resisting forces, wherein the multiple resisting forces comprise three-axis force and three-axis torque in a Cartesian coordinate system.

3. The six-axis parallel robot of claim 2, wherein in the action a01), each of the motor drivers is configured to perform an Inverse Kinematics calculation based on the target posture to obtain a linear displacement that each linear actuator needs to follow to maintain the moving platform at the target posture and generate the moving command correspondingly based on the linear displacement.

4. The six-axis parallel robot of claim 3, wherein each of the motor drivers is respectively configured to execute following actions to calculate the linear displacement of each linear actuator:
inputting the target posture of the moving platform relative to a base platform coordinate system, a first distance between a central point of the moving platform and each of the first joint components, a second distance between a central point of the base platform and each of the second joint components, a first angle representing half the value of an angle between two closest first joint components on the moving platform, and a second angle representing half the value of an angle between two closest second joint components on the base platform;
calculating a second coordinate position of each of the second joint components on the base platform coordinate system based on the second distance and the second angle;
calculating a first coordinate position of each of the first joint components on the base platform coordinate system based on the first distance and the first angle; and
based on the target posture of the moving platform relative to the base platform coordinate system, sequentially performing a coordinate transformation matrix multiplication on the first coordinate position of each of the first joint components, and taking a Euclidean distance with each corresponding second joint component to obtain the linear displacement of each linear actuator.

5. The six-axis parallel robot of claim 1, wherein each of the motor drivers is further configured to iteratively execute following actions to implement the action d):
obtaining the current posture of the moving platform, and calculating an Inverse Kinematics calculation based on the current posture to obtain a current linear displacement of linear motor;
calculating a displacement error between the current linear displacement and a target linear displacement of each linear motor, wherein the target linear displacement is caused by the external force;
calculating a linear displacement velocity array required by each linear actuator based on the displacement error and a time coefficient of an iteration algorithm;
calculating a Jacobian Matrix based on the current posture of the moving platform, and using the Jacobian Matrix to transform the linear displacement velocity array to a second linear displacement velocity array required by the moving platform;
adding the second linear displacement velocity array with the current posture of the moving platform to generate an updated current posture within iteration process;
calculating the Inverse Kinematics calculation based on the updated current posture to obtain the current linear displacement of each linear motor within the iteration process; and
repeatedly executing above actions to perform iterative updating calculation until the displacement error of each linear motor converges to a present accurate value to terminate calculating, and then outputting the updated current posture to be as the current posture of the moving platform.

6. The six-axis parallel robot of claim 1, wherein each of the motor drivers is further configured to iteratively execute following actions to implement the action e):
obtaining a linear thrust vector array of each linear actuator, wherein the linear thrust vector array directly relates to the current variation;
calculating a first coordinate position of each of the first joint components represented by a base platform coordinate system and a second coordinate position of each of the second joint components represented by the base platform coordinate system through the Inverse Kinematics calculation;
calculating a Euclidean distance of a connection line between each second joint component and each corresponding first joint component based on the first coordinate positions and the second coordinate positions;
based on the Euclidean distances, calculating a unit vector of the connection line between each second joint component and each corresponding first joint component;
based on the linear thrust vector arrays and the unit vectors, calculating an equivalent force of the moving platform relative to the external force;
calculating a connection vector between a central position of the base platform and each of the second joint components to be a force arm; and
calculating an equivalent torque of the moving platform relative to the external force based on the force arm and the equivalent force.

7. The six-axis parallel robot of claim 6, wherein each of the motor drivers is respectively configured to calculate the unit vector based on a first formula, calculate the equivalent force based on a second formula, and calculate the equivalent torque based on a third formula, wherein the first formula is:
$$\vec{{n}_{ι}} = \frac{\vec{{B}_{ι} {T}_{ι}}}{\vert \vec{{B}_{ι} {T}_{ι}} \vert} ,$$
the second formula is:
$$F = - {\sum }_{i = 1}^{6} {f}_{i} \vec{{n}_{ι}} ,$$
and the third formula is:
$$T = - {\sum }_{i = 1}^{6} \vec{{OB}_{ι}} \times {f}_{i} \vec{{n}_{ι}} ,$$
wherein nᵢ represents the unit vector, \vec{B_{ι}T_{ι}} represents the Euclidean distance, F represents the equivalent force, fᵢ represents the linear thrust vector array, T represents the equivalent torque, \vec{OB_{ι}} represents the connection vector.

8. A measuring method of a six-axis parallel robot, applied to the six-axis parallel robot having a moving platform, a base platform, multiple first joint components respectively arranged on a first surface of the moving platform, multiple second joint components respectively arranged on a second surface of the base platform, and six linear actuators respectively arranged between the moving platform and the base platform through the multiple first joint components and the multiple second joint components, wherein the moving platform has a target posture and multiple resisting forces relative to multiple directions, each of the linear actuators respectively has a linear motor and a motor driver, and the measuring method comprises following steps:
step a) controlling, by each of the motor drivers, each corresponding linear motor to rotate based on a moving command to provide a thrust to maintain the moving platform at the target posture;
step b) reading, by each of the motor drivers, a current value of each linear motor and calculating a current variation in response to the moving platform being subjected to an external force that is smaller than or equal to a thrust threshold;
step c) controlling, by each of the motor drivers, each linear actuator to perform a compliant motion and reading a linear displacement variation of each linear motor in response to the moving platform being subjected to the external force that exceeds the thrust threshold;
step d) calculating, by each of the motor drivers, a Forward Kinematics calculation based on the linear displacement variation of each linear motor to obtain a current posture of the moving platform;
step e) calculating, by each of the motor drivers, an equivalent force and an equivalent torque of the moving platform relative to the external force based on the current variation of each linear motor and the current posture; and
step f) comparing, by each of the motor drivers, the current posture and the target posture to calculate a displacement and an angle variation of the moving platform.

9. The measuring method of claim 8, further comprising:
step a01) receiving an external operation to set the target posture of the moving platform and generating the moving command of controlling each corresponding linear motor based on the target posture; and
step a02) receiving the external operation to set the multiple resisting forces of the moving platform relative to the multiple directions and set the thrust threshold based on the multiple resisting forces, wherein the multiple resisting forces comprise three-axis force and three-axis torque in a Cartesian coordinate system.

10. The measuring method of claim 9, wherein the step a01) comprises performing, by each of the motor drivers, an Inverse Kinematics calculation based on the target posture to obtain a linear displacement that each linear actuator needs to follow to maintain the moving platform at the target posture and generate the moving command correspondingly based on the linear displacement.

11. The measuring method of claim 10, wherein the step a01) further comprises:
step a011) inputting the target posture of the moving platform relative to a base platform coordinate system, a first distance between a central point of the moving platform and each of the first joint components, a second distance between a central point of the base platform and each of the second joint components, a first angle representing half the value of an angle between two closest first joint components on the moving platform, and a second angle representing half the value of an angle between two closest second joint components on the base platform;
step a012) calculating a second coordinate position of each of the second joint components on the base platform coordinate system based on the second distance and the second angle;
step a013) calculating a first coordinate position of each of the first joint components on the base platform coordinate system based on the first distance and the first angle; and
step a014) based on the target posture of the moving platform relative to the base platform coordinate system, sequentially performing a coordinate transformation matrix multiplication on the first coordinate position of each of the first joint components, and taking a Euclidean distance with each corresponding second joint component to obtain the linear displacement of each linear actuator.

12. The measuring method of claim 8, wherein the step d) comprises:
step d1) obtaining the current posture of the moving platform, and calculating an Inverse Kinematics calculation based on the current posture to obtain a current linear displacement of linear motor;
step d2) calculating a displacement error between the current linear displacement and a target linear displacement of each linear motor, wherein the target linear displacement is caused by the external force;
step d3) calculating a linear displacement velocity array required by each linear actuator based on the displacement error and a time coefficient of an iteration algorithm;
step d4) calculating a Jacobian Matrix based on the current posture of the moving platform, and using the Jacobian Matrix to transform the linear displacement velocity array to a second linear displacement velocity array required by the moving platform;
step d5) adding the second linear displacement velocity array with the current posture of the moving platform to generate an updated current posture within iteration process;
step d6) calculating the Inverse Kinematics calculation based on the updated current posture to obtain the current linear displacement of each linear motor within the iteration process; and
step d7) repeatedly executing above steps to perform iterative updating calculation until the displacement error of each linear motor converges to a present accurate value to terminate calculating, and then outputting the updated current posture to be as the current posture of the moving platform.

13. The measuring method of claim 8, wherein the step e) comprises:
step e1) obtaining a linear thrust vector array of each linear actuator, wherein the linear thrust vector array directly relates to the current variation;
step e2) calculating a first coordinate position of each of the first joint components represented by a base platform coordinate system and a second coordinate position of each of the second joint components represented by the base platform coordinate system through the Inverse Kinematics calculation;
step e3) calculating a Euclidean distance of a connection line between each second joint component and each corresponding first joint component based on the first coordinate positions and the second coordinate positions;
step e4) based on the Euclidean distances, calculating a unit vector of the connection line between each second joint component and each corresponding first joint component;
step e5) based on the linear thrust vector arrays and the unit vectors, calculating an equivalent force of the moving platform relative to the external force;
step e6) calculating a connection vector between a central position of the base platform and each of the second joint components to be a force arm; and
step e7) calculating an equivalent torque of the moving platform relative to the external force based on the force arm and the equivalent force.

14. The measuring method of claim 13, wherein the step e4) comprises calculating the unit vector based on a first formula, the step e5) comprises calculating the equivalent force based on a second formula, and the step e7) comprises calculating the equivalent torque based on a third formula, wherein the first formula is:
$$\vec{{n}_{ι}} = \frac{\vec{{B}_{ι} {T}_{ι}}}{\vert \vec{{B}_{ι} {T}_{ι}} \vert} ,$$
the second formula is:
$$F = - {\sum }_{i = 1}^{6} {f}_{i} \vec{{n}_{ι}} ,$$
and the third formula is:
$$T = - {\sum }_{i = 1}^{6} \vec{{OB}_{ι}} \times {f}_{i} \vec{{n}_{ι}} ,$$
wherein nᵢ represents the unit vector, \vec{B_{ι}T_{ι}} represents the Euclidean distance, F represents the equivalent force, fᵢ represents the linear thrust vector array, T represents the equivalent torque, \vec{OB_{ι}} represents the connection vector.
